(19) United States
(12) Patent Application Publication
(10) Pub. No.: US 2002/0163917 A1
(43) Pub. Date: Nov. 7, 2002

(54) Pre-lookup method for internet addressing

(75) Inventors: Jin-Ru Chen, Taichung (TW); Yao-Tzung Wang, Hsinchu (TW)

Correspondence Address: DARBY & DARBY P.C., 805 THIRD AVENUE, NEW YORK, NY, 10022, US

(73) Assignee: Acute Communications Corporation

(21) Appl. No.: 09/967,747

(22) Filed: Sep. 28, 2001

(30) Foreign Application Priority Data
May 2, 2001 (TW) 90110466

(51) Int. Cl. H04L 12/56

(52) U.S. Cl. 370/395.32

(57) ABSTRACT

An Internet address pre-lookup method, suitable for an Internet packet delivery system using a routing table and hash table. First, a pre-lookup table including a plurality of pre-lookup bits in the system is provided, each pre-lookup bit corresponding to a converting address, when any Internet address corresponding to the converting address exists in the routing table, then the pre-lookup bit corresponding to the converting address is set as valid. A packet including a destination address is received, and the pre-lookup bit corresponding to the converting address the same as the valid address of the destination address is checked in the pre-lookup table. When the pre-lookup bit corresponding to the converting address the same as the valid address of the destination address is invalid, a default process is directly performed on the packet.

### BACKGROUND OF THE INVENTION

1. Field of the Invention

The present invention relates to a pre-lookup method for Internet addressing, more particularly, to an Internet address pre-lookup method that directly filters the destination address, accepting the default process in the Application Specific Integrated Circuit (ASIC).

2. Description of the Prior Art

The main function of the Internet switch is to connect different networks and to deliver information between these different networks. That is, when the switch receives an Internet packet, a routing process is performed on the packet, which is then delivered through a port of the switch according to the result of the routing process.

The routing process on the layer 3 switch is mainly to compare the destination address in the packet received and the routing table. The routing table records the port of the delivered packet that corresponds to the different Internet addresses. The packet is then delivered according to the corresponding port of the same Internet address after comparison in the routing table.

FIG. 1 shows a flow chart of the conventional Internet address lookup method. First, the system provides a hash table (step S102). This hash table records the Internet addresses that are frequently compared in the routing table and the corresponding ports. Then, the system receives a packet that contains a destination address (step S106). If the destination address exists in the hash table, the packet is directly delivered to the corresponding port of the Internet address that is found to be the same in the hash table (step S108). If the destination address does not exist in the hash table, then the packet undergoes a software routing process (step S110).

In the above described conventional Internet address lookup method, because use of the hash table requires fast execution of the routing selection process, hardware can be employed to operate (i.e. can operate in the Application Specific Integrated Circuit layer). However, since the size of whole processing chips is getting smaller, it is impossible to provide hash tables with unlimited operation. Therefore, the system needs stronger processing ability from the central processing unit (CPU), to deal with the software routing process of unknown destination addressing.

Since Internet addresses that can be covered by the routing table only accounts for a small portion, for most destination addressing, a pre-determined processing system is preferable. For example, the default route defined in conventional routers is a typical case.

### SUMMARY OF THE INVENTION

Therefore, the main object of the present invention is to provide an Internet address pre-lookup method that directly filters Internet addresses accepting predetermined processing in an ASIC layer. After filtering, the system only needs to process according to the recorded Internet address in the routing table. This reduces the burden of system processing software routing and increases the packet delivery rate.

To achieve the above object, the present invention provides an Internet address pre-lookup method suitable for Internet packet delivery that contains routing and hash tables.

First, a pre-lookup table containing a plurality of pre-lookup bits is provided. Each pre-lookup bit corresponds to a converting address. When the Internet address corresponding to the converting address exists in a routing table, the pre-lookup bit corresponding to the exchange address is valid.

Next, a packet including a destination address is received. The pre-lookup bit corresponding to the converting address that is the same as the valid address of the destination address is checked. When the pre-lookup bit corresponding to the converting address that is the same as the valid address of the destination address is invalid, predetermined processing is performed on the packet.

When the pre-lookup bit corresponding to the converting address that is the same as the valid address of the destination address is valid, the destination address and hash table are compared to look for matching items. If the matched item exists in the hash table, the packet is transmitted from the port in the matched item. If the matched item does not exist in the hash table, software routing is performed on the packet.

### BRIEF DESCRIPTION OF THE DRAWINGS

The following detailed description, given by way of example and not intended to limit the invention solely to the embodiments described herein, will best be understood in conjunction with the accompanying drawings, in which:

FIG. 1 is a flow chart of a conventional Internet address lookup method.

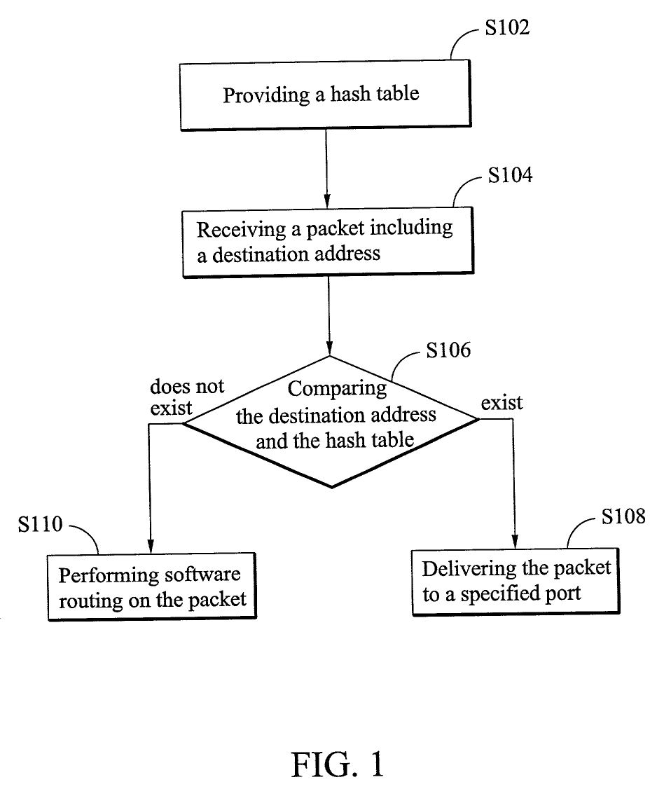

FIG. 2 is a flow chart of an Internet address lookup method according to the embodiment of the present invention.

### DETAILED DESCRIPTION OF THE PREFERRED EMBODIMENT

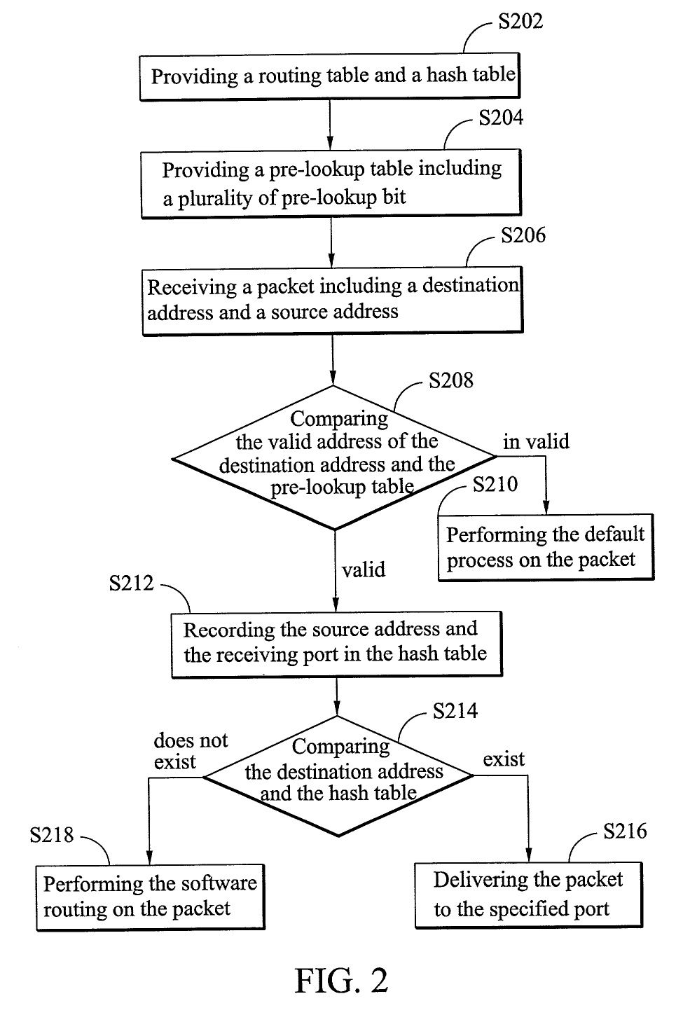

FIG. 2 is a flow chart of the Internet address lookup method according to the embodiment of the present invention. Referring to FIG. 2, the embodiment of the present invention is be described in detail below.

The Internet address lookup method of the embodiment of the present invention is suitable for an Internet packet delivery system. First, a routing table is provided to record the port of the delivered packet corresponding to different Internet addresses and a hash table is provided to record Internet addresses frequently compared in the routing table and the corresponding port (step S202).

The system also provides a pre-lookup table that contains a plurality of pre-lookup bits (step S204). Each pre-lookup bit corresponds o a converting address. When the Internet address corresponding to the converting address exists in the routing table (i.e. when the Internet address is recorded in the routing table), the pre-lookup bit corresponding to the converting address is valid.

The relationship between the converting address and the Internet address can be a one-to-many mapping relation. For example, if the converting address is 16 bit and the address value is 10.10 (in decimal), then the Internet address can be of 32 bits and the address value can be all addresses ranging from 10.10.1.1 to 10.10.255.255. Thus, if an address data 10.10.50.1 is recorded in the routing table, the pre-lookup bit corresponding to converting address 10.10 in the pre-lookup table is considered valid.

Then, when the system receives a packet that contains a destination address and a source address (step S206), the pre-lookup bit corresponding to the converting address the same as the valid address of the destination address in the packet is checked in the pre-lookup table (step S208).

The relationship between the destination address and the valid address can be a many-to-one mapping relationship. For example, if the destination address is 32 bits and the address value is 10.10.50.1 (in decimal), then the valid address can be the heading 16 bit data of the 32 bit data and the address value is 10.10.

If the pre-lookup bit corresponding to the converting address the same as the valid address of the destination address is invalid (i.e. there are no Internet addresses of the converting address in the routing table), then a default process is performed on the packet (step S210). The default process can directly deliver this packet through a certain port or discard this packet. The system can select either according to the situation.

On the other hand, if the pre-lookup bit corresponding to the converting address that is the same as the address of the destination address is valid (i.e. at least one of the Internet address of the converting address is recorded in the routing table), then the system performs address learning and records the source address in the packet and the incoming port received in the packet to hash table (step S212).

The system then compares the destination address and the hash table, looks for the matched item the same as the destination address (step S214). If the matched item exists in the hash table, the packet is delivered through the port recorded in the matched item (step S216); if the matched item does not exist in the hash table, software routing is performed on the packet (step S218), comparing the destination address and routing table and finding the port to be delivered by the packet

In the above embodiment, the checking of the pre-lookup bit in the pre-lookup table (step S208) and the comparison with the hash table (step S214) can be performed at the same time, however the result of the comparison with the hash table can only be used if the pre-lookup bit is valid. <Updating the routing table>

For the updating of the routing table, the system can provide an update table that contains a plurality of counters. Each counter corresponds to a converting address that corresponds to each pre-lookup bit in the pre-lookup table, i.e. the number of counters is the number of the pre-lookup bit in the pre-lookup table and each counter and the pre-lookup bit correspond to a converting address.

When the routing table wants to increase a first address and port data, the counter of the converting address covered by the first valid address of the first address corresponding to the update table is increased by 1.

For example, assuming that the number of bits of the first valid address is h and the converting address in the pre-lookup table is of k bits, when the first address is a₀a₁a₂. . . a_{g}, aᵢ in {0,1}. If h>k, then the counter corresponding to the converting address a₀a₁. . . aₖ₋₁ in the update table is increased by 1; if h ≦k, every counter that corresponds to the converting address a₀a₁. . . aₕ₋₁0 . . . 0 to a₀a₁. . . aₕ₋₁1 . . . 1 in the update table must be increased by 1. For example, if k is of 16 bits, and the first address 10.0.0.0 (in decimal) of 8 bit valid address (h=8) to be increased, then the counters that correspond to the converting address 10.0 to 10.255 in the update table must all be increased by 1; if the first address 1010.10.0 of 16 bit valid address (h=16) is to be increased, then the counter that corresponds to the converting address 10.10 in the update table is increased by 1. In addition, the pre-lookup bits corresponding to the converting address in the pre-lookup table are considered valid.

In addition, when the routing table intends to delete a second address and the port data, the counter of the converting address covered by the second valid address corresponding to the second address in the update table is decreased by 1.

For example, assuming that the second valid address is of h bits and the converting address in the pre-lookup table is of k bits, when the second address is a₀a₁a₂. . . a_{g}, aᵢ belongs to {0,1}. If h>k, the counter corresponding to the converting address a₀a₁. . . aₖ₋₁ in the update table is decreased by 1; if h ≦k, then counters corresponding to all converting addresses a₀a₁. . . aₕ₋₁0 . . . 0 to a₀a₁. . . aₕ₋₁1 . . . 1 in the update table must be decreased by 1. In addition, if the counters corresponding to these converting addresses equal zero, then the pre-lookup bits corresponding to these converting addresses in the pre-lookup table are set to be invalid.

Furthermore, the modifying situation in the routing table can be considered as: the deletion is first performed, followed by an increasing action, so the modifying operation in the routing table is omitted.

In the embodiment of the present invention, since the pre-lookup table is provided in the ASIC layer, the size of the chip can be reduced by the one-to-many mapping relationship between the converting address and the Internet address in the pre-lookup table, however, if the chip size is not critical, the relationship between the converting address and the Internet address in the pre-lookup table can be a one-to-one mapping relationship.

In addition, in order to reduce chip size, the update table provided by the embodiment of the present invention can be recorded using software instead of being designed in a hardware form. However, if the chip size is not critical, the update table can combine with the pre-lookup table and be designed in the ASIC layer.

Therefore, the Internet packet deliver system can first filter the Internet address that will receive a default process in the ASIC layer through the Internet address pre-lookup method of the present invention when performing fast packet delivery. After filtering, the system only needs to process the Internet address recorded in the routing table. This reduces the burden of the system process software routing and increases the rate of packet delivery.

While the invention has been described by way of example and in terms of the preferred embodiment, it is to be understood that the invention is not limited to the disclosed embodiments. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. An Internet address pre-lookup method, suitable for an Internet packet delivery system, comprising the following steps:
providing a routing table;
providing a pre-lookup table including a plurality of pre-lookup bits, wherein each pre-lookup bit corresponds to a converting address, and the pre-lookup bit corresponding to the converting address is valid if any one of the Internet addresses corresponding to the converting address exists in the routing table;
receiving a packet that contains a destination address; checking the pre-lookup bit corresponding to the converting address the same as the valid address of the destination address in the pre-lookup table; and
performing a default process on the packet if the pre-lookup bit corresponding to the converting address the same as the valid address of the destination address is invalid.

2. The method as claimed in claim 1, further comprising: providing a hash table; and
comparing the destination address and the hash table so as to find a matched item if the pre-lookup bit corresponding to the converting address the same as the valid address of the destination address is valid.

3. The method as claimed in claim 2, further comprising:
delivering the packet through the port in the matched item if the matched item exists in the hash table; and
performing software routing on the packet if the matched item does not exist in the hash table.

4. The method as claimed in claim 2, wherein the packet further comprises a destination address, and the source address and the receiving port receiving the packet are recorded to the hash table if the pre-lookup bit corresponding to the converting address the same as the valid address of the destination address is valid.

5. The method as claimed in claim 1, further comprising:
providing an update table including a plurality of counters, wherein each counter corresponds to the converting address corresponding to the pre-lookup bit in the pre-lookup table;
increasing the counter of the converting address covered by the first valid address corresponding to the first address in the update table by one, and setting the pre-lookup bit corresponding to the converting address in the pre-lookup table as valid if a first address is added to the routing table; and
decreasing the counter of the converting address covered by the second valid address corresponding to the second address in the update table by one if a second address is deleted from the routing table, and setting the pre-lookup bit corresponding to the converting address in the pre-lookup table invalid if the counter is equal to zero.

6. The method as claimed in claim 1, wherein the default process directly delivers the packet through a certain port.

7. The method as claimed in claim, wherein the default process discards the packet.

8. An Internet address pre-lookup method, suitable for an Internet packet delivery system, the method comprising the following steps:
providing a routing table and a hash table;
providing a pre-lookup table including a plurality of pre-lookup bits, each pre-lookup bit corresponding to a converting address, the pre-lookup bit corresponding to the converting address recognized as valid if any of the Internet addresses corresponding to the converting address exist in the routing table;
receiving a packet containing a destination address;
comparing the destination address and the hash table to find matched items;
checking the pre-lookup bit corresponding to the converting address the same as the valid address of the destination address in the pre-lookup table; and
performing a default process on the packet if the pre-lookup bit corresponding to the converting address the same as the valid address of the destination address is invalid.

9. The method as claimed in claim 8, further comprising:
delivering the packet from the port in the matched item if the pre-lookup bit corresponding to the converting address the same as the valid address of the destination is valid, and the matched item exists in the hash table; and
performing software routing on the packet if the pre-lookup bit corresponding to the converting address the same as the valid address of the destination address is valid, and the matched item does not exist in the hash table.

10. The method as claimed in claim 8, wherein the packet further includes a source address, and the source address and the receiving port receiving the packet are recorded to the hash table if the pre-lookup bit corresponding to the converting address the same as the valid address of the destination address is valid.

11. The method as claimed in claim 8, further comprising:
providing an update table including a plurality of counters, wherein each counter corresponds to the converting address corresponding to each pre-lookup bit in the pre-lookup table;
increasing the counter of the converting address covered by the first valid address corresponding to the first address in the update table by one, and setting the pre-lookup bit corresponding to the converting address in the pre-lookup table valid if a first address is added to the routing table; and
decreasing the counter of the converting address covered by the second valid address corresponding to the second address in the update table by one if a second address is deleted form the routing table, and setting the pre-lookup bit corresponding to the converting address in the pre-lookup table invalid if the counter is equal to zero.

12. The method as claimed in claim 8, wherein the default process is directly delivers the packet through a certain port.

13. The method as claimed in claim 8, wherein the default process discards the packet.
